(19) United States
(12) Patent Application Publication
(10) Pub. No.: US 2014/0303911 A1
(43) Pub. Date: Oct. 9, 2014

(54) METHOD FOR MEASURING THE ENERGY OF PULSES OF OPTICAL RADIATION AND DEVICE FOR IMPLEMENTING SAME

(71) Applicants: Leonid Vasilevich Levash, Kiev (UA); Yuri Grigorievich Ptushinskii, Kiev (UA); Volodymyr Borisovich Samoylov, Kiev (UA)

(72) Inventors: Leonid Vasilevich Levash, Kiev (UA); Yuri Grigorievich Ptushinskii, Kiev (UA); Volodymyr Borisovich Samoylov, Kiev (UA)

(21) Appl. No.: 13/992,900

(22) PCT Filed: Nov. 28, 2011
(86) PCT No.: PCT/UA2011/000120

§ 371 Date: Aug. 7, 2013

(30) Foreign Application Priority Data
Dec. 14, 2010 (UA) A 2010 15029

(51) Int. Cl. G01J 5/34

(52) U.S. Cl. CPC G01J 5/34
USPC 702/57

(57) ABSTRACT

What are described are: method and a device for measuring the energy of impulses of optical radiation, with aid of which a measurement error associated with the indeterminacy of the precise time at which impulse occurred between discrete readings of an analog-digital converter is reduced. The useful effect is, achieved by means of introducing a normalizing impulse converter which generates impulse electrical signals with a standard form which is not dependent on the form of the radiation impulses, and a corresponding procedure for digital signal processing.

Invention belongs to methods of measuring the energy of impulse of optical radiation primary for laser and for devices that measure energy of impulses of optical radiation and can be used in technologic equipment and medical devices for determination of energetic characteristics of impulse lasers.

In our time overwhelming majority of measurers of energy radiation in wide spectral range of leading firms in highly-developed countries such as “Coherent”, “Spectrum Detector”, “Newport” and others are based on pyroelectric detectors of radiation. This is due to the fact that they combine nonselectivity peculiar to thermal detectors and high operation speed which is in some cases equal to operation speed of photo-electric detectors and exceed photo-electric detectors by range of linearity. Besides, mode of integration is one of operation modes of pyroelectric detectors at which electric signal is proportional to total energy of impulse radiation that allows to simplify schemes of measuring instruments and improve accuracy of measurement. All of this gives rise to interest to development of devices that are based on pyroelectric radiation detectors and measuring methods of energy impulse radiation with it help.

Well known method of determination of impulse energy with the help pyroelectric detector that is described in book of V. F. Kosorotov, L. S. Kremenchutskiy, V. B. Samoylov and L. V. Shchedrina “Pyroelectric effect and it practical application”, Kiev, Naukova dumka, 1989 (p. 149). Method lies in irradiation of detector that operates in integrating mode by impulse that is shorter than electrical time constant of detector (τimp<<τₑₗ) and signal amplitude measurement at the moment of impulse finishing. Measuring amplitude that is multiplied on calibrating coefficient of measurer gives us value of impulse energy.

Above mentioned method may be realized with the help of device that is described in article O. Touayar et al. “Experimental evaluation of a pyroelectric detector linearity used for pulsed laser energy absolute energy” (“Sensors and Actuators”, A 120 (2005), 482-489). This device consists of two blocks. First one represents the pyroelectric sensor with preamplifier in which amplitude of impulse output signal is proportional to energy of laser impulse. Second block is designed for determination of its amplitude. It consists of comparing circuit, two monostable multivibrators and integrator. In the comparing circuit amplitude of signal is compared with threshold value which corresponds to electrical and acoustical noises. In the case of exceeding of threshold value comparing circuit turns on the first monostable multivibrator. It generates impulse with the time shift that corresponds to time of signal increasing T_{M} and turns on the second monostable multivibrator. Second monostable multivibrator turns on the integration circuit which generates the initial voltage that is proportional to amplitude of pyroelectric signal.

Disadvantage of such method and device for its realization is the low accuracy of energy impulse measurement caused by non-controllable errors that arise during shift formation in system of monostable multivibrator. Absence of digital statistical processing of signal and noise also influences on accuracy of measurement of the single signal amplitude. It greatly increases the error of measurement particularly in the case of gradual and slow drop of optical impulse amplitude or in the case of presence of piezo-electric oscillations that appear in volume of detector under action of short impulse of radiation.

The closest method and device for measuring energy of laser impulses are “Method and apparatus for measuring laser pulse energy” (U.S. Pat. No. 5,980,101 Int.Cl.⁶ G01K 17/00, authors: J. R. Unternahrer, F. R. Stayer, Sep. 11, 1999), in which first laser impulse is delivered to the energy detector that generates the first electric signal that corresponds to the first laser impulse with the help of which time constant of the energy detector is determined, and the second impulse leads to generation by pyroelectric detector of the second signal that serves for precise determination of second laser impulse energy with taking into account time constant of the detector.

The method is performed with the help of the device that consists of energy detectors which receive laser radiation and generate signal that is relevant to energy of laser radiation with afterfiltration, an analog-digital converter and computer. Computer calculates the time constant of the detector basing on the converted signal from first laser impulse and after that calculates energy of the second laser impulse on the base of the converted signal from second laser impulse and time constant of the detector. Presence of computer-assisted data processing system allows to increase an accuracy of measurement of laser radiation energy using analysis of signal statistical properties, noise, acoustic and electric interferences.

Disadvantage of such method and device for its realization is low accuracy of impulse energy measurement caused by the fact that it is necessary to use a wide-band coupling amplifier of detector for impulses of different forms and durations that leads to increasing of noise voltage and decreasing of the signal/noise ratio.

Another disadvantage of such method is that the analog-digital conversion of signal that is connected with fixation of its value in separate discrete moments of time does not allow to define accurately the moment of impulse appearance and moment when it reaches the maximum level that leads to decreasing of accuracy and integrity of obtaining results of measurement.

Aim of this invention is to increase a measuring accuracy of laser impulse radiation energy using improvement of measuring method of energy laser radiation and device in which this method is realized with the help of removing mentioned above disadvantages.

The set problem is solved with the help of recommended method which lies in irradiation of pyroelectric detector by impulse of optical radiation, filtration and amplification of electric signal which after that come into analog-digital converter (ADC), subsequent transfer of the digital pattern of signal in computer and next mathematical treatment that consists of determination of zero level on the part of digital pattern of signal that precedes to the impulse start, spotting of the dropping section of signal after its extremum, its extrapolation and estimation of energy of impulse, with that the electric signals that respond to radiation impulses of different forms and durations are converted preliminarily in the electric impulses of the same form, and marked section is approximated by straight line, and beginning moment of impulse radiation (t_{H}) is calculated with the help of formula t_{H}=t₀+Δ, where t₀—is time of appearance of first nonzero reading and Δ—is time interval between beginning of impulse and moment of appearance of first reading U1:

$$Δ = - τ 1 \cdot ln ( \frac{U 2 - U 1}{U 2 - U 1 \cdot {e}^{- \frac{T}{τ 1}}} ) ,$$

where T—is a time period between two neighbor samples of ADC, τ1—is time constant of input chain of the coupling amplifier, U1 and U2—are amplitudes of first and second nonzero samples correspondently. Energy of impulse is calculated as value of approximating straight line at the moment of impulse beginning t_{H} that is multiplied on calibrating coefficient of energy measuring instrument.

The set problem can be solved also with the help of recommended measuring instrument which consists of pyroelectric detector, coupling amplifier, output of which is connected to input of analog-digital converter, output of which is connected to computer. Output, of detector is connected to the input of normalizing transducer of impulses, output of which is connected to the input of coupling amplifier, with that the normalizing transducer of impulses is performed in such a way that its frequency-response characteristic lies in interval of frequencies between (τᵢₙₜ)⁻¹ and upper limit of operation frequency range, where tᵢₙₜ—time constant of integrating circuit of coupling amplifier. This provides getting in output of coupling amplifier electrical impulses with spectrum which lies in this frequency range.

Let us consider signal conversion under measurement of energy of laser impulse with the help of mentioned above method and measuring instrument. The response of the unit of pyroelectric converter to radiation impulse with length of 10 nanoseconds is depicted in FIG. 1 (curve 1). Additional filter with time constant of 3 microseconds forms the impulse electric signals of standard form (curve 2) which does not depend from forms of radiation impulses in all operation range of lengths (<10 microseconds). Curve 3 displays form of signal on the output of coupling amplifier with time constant of integration that equal 100 microseconds. Its amplitude is proportional to total energy of radiation.

Process of energy impulse calculation is carried out on the base of package of impulse instantaneous values which accumulates for each fixed impulse during of measurement in real time mode. Graphic image of package impulse instantaneous values and drawing of digital processing methods of such package with of getting numeric value of such impulse energy are listed in FIG. 2.

Every package consists of 32 instantaneous values of voltage Y(0), Y(1) . . . Y(31) which piece out digital pattern of impulse. Package consists of three typical intervals:
Relative zero level of signal—interval I,
Leading edge of impulse—interval II: from first nonzero reading to maximum (point b),
Trailing edge of impulse—interval III.

Relative zero level of signal is approximated with the help of horizontal straight line (1), level of which is obtained with the help of assortment of subset values Y(0) . . . Y(12) (point a on straight line (1)). The package of instantaneous values after process execution of assortment of subsets Y(0) . . . Y(12) is described in FIG. 2. In such a manner value approximate zero level of signal is equal to the value Y(6).

Leading edge of impulse is approximated with aim to determine the calculated moment of impulse leading edge t_{H} (point c). For decreasing value of the error of evaluation of calculated moment of beginning of leading edge of impulse we proposed and realized in software of the energy measuring instrument some new technique of signal processing that gives a possibility to define tH with error much less than time T between neighbor starts of ADC.

Let us consider the general case when electrical impulse from pyroelectric detector with length τᵢₘₚ through input circuit with time constant τ₁ come into input of coupling amplifier with the time integration constant τ₂ and relationship τ₁<<τ₂ is fulfilled. Time dependence of output signal U(t) of coupling amplifier under short input impulse (τᵢₘₚ<τ₁) with amplitude U₀ is given with the accuracy up to a constant by:

$$U ( t ) = {U}_{0} \cdot ( 1 - {e}^{- \frac{t}{τ 1}} ) \cdot {e}^{- \frac{t}{τ 2}} . \qquad ( 1 )$$

From this expression it follows that the form of amplifier output signal U(t) under irradiation of detector by short impulse does not depend from length of impulse τᵢₘₚ and is fully describing by combination of constants τ₁ and τ₂.

For time interval 0≦t<T with taking into account relation τ₁<τ₂ for first two nonzero values of readings (U1 and U2 respectively) analog-digital transformation of function U(t) in general form can be written as:

$$\begin{matrix}\{ \begin{matrix}U 1 = {U}_{0} \cdot ( 1 - {e}^{- \frac{Δ}{τ 1}} ) \\ U 2 = {U}_{0} \cdot ( 1 - {e}^{- \frac{( Δ + T )}{τ 1}} )\end{matrix} , & ( 2 )\end{matrix}$$

where Δ—is interval of time between beginning of impulse and moment when reading U1 takes place, T—is time interval between two neighbor samples of ADC. Expected uncertainty of impulse beginning time and the value of Δ are respectively the essential components of an error of measurement energy of radiation.

Solving the system (2) relative to value Δ one can obtain:

$$Δ = - τ 1 \cdot ln ( \frac{U 2 - U 1}{U 2 - U 1 \cdot {e}^{- \frac{T}{τ 1}}} ) \qquad ( 3 )$$

Errors of energy measurement of impulse depending on time interval t between beginning of impulse and first next reading of ADC for moments of time 0≦t<T are shown in FIG. 3 (—without including correction, ▪|—with taking into account correction by formula (3)). Calculations are performing at nextparameters: T=3,4 microseconds, τ1=2,5 microseconds and τ2=100 microseconds.

From graphs is following that:
For both of methods increasing of time interval between beginning of impulse and moment of reading U1 lead to increasing of error of energy impulse determination;
Maximum value of error of energy determination without taking into account correction Δ is equal to 2,6%;
Maximum value of error of energy determination with taking into account correction Δ is equal to 0,25%;

Taking into account of correction A decreases this component of measurement error up to 10 times. In such a way calculation of correction A by formula (3) allows to decrease error caused by the uncertainty of impulse beginning moment and increases accuracy of determination of impulse radiation energy.

Trailing edge of impulse (interval III, FIG. 2) is approximated with straight line with the help of least-squares method. For it from package of instantaneous values of impulse is marked a subset Y(20) . . . Y(27) that knowingly is situated on trailing edge of impulse. Through points Y(20) . . . Y(27) by least-squares method is drawn approximated straight line (straight line (2)) and coefficients values A and B of this straight line are found.

After that in equation of straight line with coefficients A and B value of argument X(c) is substituted and value of estimated amplitude of impulse (point d on straight line (2)) in volts is found as

U=A·X(c)+B (4)

where: A, B—are coefficient of approximated straight line, X(c)—is estimated time of impulse beginning.

Energy of impulse is calculated by formula:

E=U·K·K1 (5)

where: K—is volt-joule sensitivity of pyroelectric detector on wave length of calibration.

K1—is coefficient of relative sensitivity on wave length of radiation.

In such a way an application of mentioned above method and device for measuring of energy impulses of optical radiation allows to decrease the error of measurement which connected with uncertainty of exact time of impulse arising between two discrete readings of analog-digital converter. Useful effect is achieved with the help, of using of normalizing transducer of impulses which forms impulse electric signals of standard form which does not depend on form of radiation impulse, and corresponding procedure of digital signal processing.

### FIGURE CAPTIONS

FIG. 1. Block answer of pyroelectric converter on radiation impulse with length 10 nanoseconds: 1—impulse form of current which generate by pyroelectric detector. 2—form of signal on output from additional filter with time constant 3 microseconds, 3—form of signal on output of coupling amplifier with time constant of integration 100 microseconds.

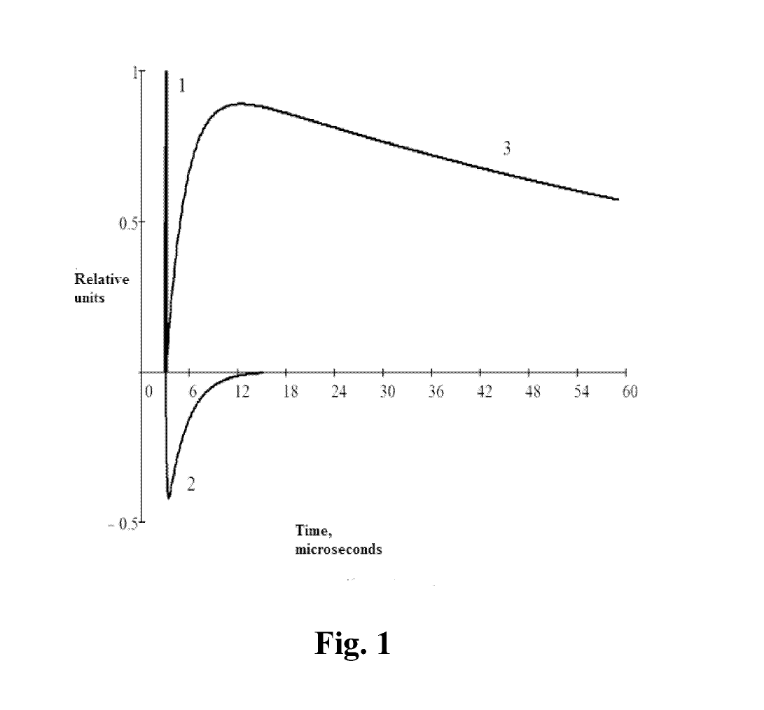

FIG. 2. Graphic presentation of package of instantaneous values of impulse and illustration of digital processing methods.

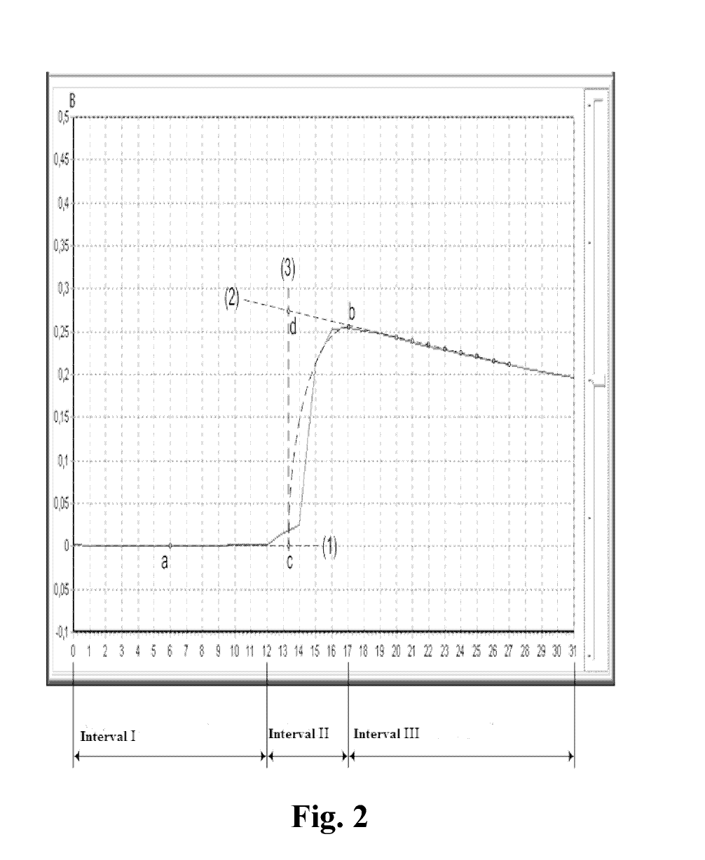

FIG. 3. Measurement errors of impulse energy depending on time interval t between beginning of impulse and the first next reading of ADC for time moments 0≦t<T (—without including correction, ▪|—taking into account correction by formula (3)).

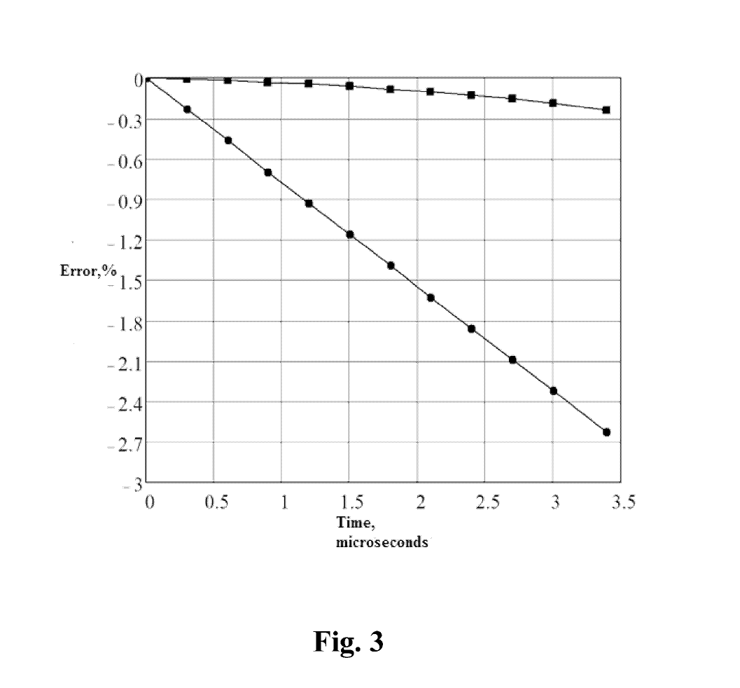

1. Measuring method of impulse energy of optical radiation which consists in irradiation of pyroelectric detector by impulse. filtration and amplification of electric signal, which after that come into analog-digital convertor (ADC), the following transmission of digital pattern of signal into computer with the next mathematical treatment which consists of determination of zero level by part of digital pattern of signal which precedes to impulse beginning, extracting of the drop area of signal after its extremum, its extrapolation and calculation of impulse energy which differs in that the electrical signals that correspond to radiation impulses of different forms and lengths are transformed into electrical impulses of similar form and length, the marked area is approximated by straight line and moment of impulse radiation beginning is calculated by formula t_{H}=t₀+Δ, where to t₀—time of arising of the first, nonzero reading, and
$$Δ = - τ 1 \cdot ln ( \frac{U 2 - U 1}{U 2 - U 1 \cdot {e}^{- \frac{T}{τ 1}}} )$$
where: T—is time interval between two neighbor samples of ADC, τ¹—is input time constant of coupling amplifier, U1 and U2—are amplitudes of first and second nonzero samples respectively, and energy of impulse is calculated as the value of approximating straight line in the moment of impulse beginning t_{H}, multiplied on the calibrating coefficient of energy meter.

2. Energy meter of impulse radiation which consists of pyroelectric detector, coupling amplifier, output of which is connected to computer, which differs in that the output of detector is connected to input of normalizing transducer of impulses, output of which is connected to input of coupling amplifier, notably normalizing transducer of impulses is performed in such a way that upper limit of spectrum of its output impulses does not exceed upper limit of operation frequency range of coupling amplifier.
